(19) United States
(12) Patent Application Publication
(10) Pub. No.: US 2023/0024076 A1
(43) Pub. Date: Jan. 26, 2023

(54) SNOWBOARD FIXING FRAME

(71) Applicant: YOTTA INNOVATION CO., LTD., APIA (WS)

(72) Inventor: Stella HUANG, Taipei City (TW)

(21) Appl. No.: 17/957,031

(22) Filed: Sep. 30, 2022

Related U.S. Application Data
(63) Continuation-in-part of application No. 17/381,601, filed on Jul. 21, 2021, now Pat. No. 11,491,921.

(51) Int. Cl. B60R 9/08; B60R 9/06; E05B 65/00

(52) U.S. Cl. CPC B60R 9/08; B60R 9/06; E05B 65/00

(57) ABSTRACT

A snowboard fixing frame includes a frame body, a fixing assembly, an restricting member and a locking mechanism. The fixing assembly is disposed on the frame body and includes a first rod and a second rod for clamping a snowboard. The restricting member is screwed on the first rod and is rotatable relative to the first rod to adjust a distance between a first restricting portion of the restricting member and the first rod. The restricting member has a first restricting portion. The locking mechanism includes a base, a core member, a locking member and an elastic member. The base is disposed on the second rod and within a first hole. The core member is rotatable with the locking member.

The present invention is a CIP of application Ser. No. 17/381,601, filed Jul. 21, 2021, the entire contents of which are hereby incorporated by reference.

### BACKGROUND OF THE INVENTION

### Field of the Invention

### Description of the Prior Art

The snowboard is too long to be placed in the vehicle, so it is necessary to use a specific fixing frame to fix the snowboard, wherein the fixing frame is generally mounted to the roof or the back of the vehicle. However, the conventional snowboard fixing frame is worse in anti-theft, or the operation process of the fixed frame with good anti-theft effect is cumbersome, which makes the snowboard easy to be stolen or causes inconvenience when the user accesses the snowboard.

In addition, the conventional snowboard fixing frame is non-adjustable and only suitable to restrict the snowboards with specific specifications, which has limited application range and may result in damages to the snowboards or the components of the snowboard fixing frame by over-tightening.

The present invention is, therefore, arisen to obviate or at least mitigate the above-mentioned disadvantages.

### SUMMARY OF THE INVENTION

The main object of the present invention is to provide a snowboard fixing frame which facilitates installation/uninstallation of a snowboard and is burglarproof.

To achieve the above and other objects, the present invention provides a snowboard fixing frame, including: a frame body, a fixing assembly, a restricting member and a locking mechanism. The frame body is configured to be connected to a vehicle. The fixing assembly is disposed on the frame body and includes a first rod and a second rod, and at least one of the first rod and the second rod is rotatable relative to the frame body to clamp a snowboard. The first rod has a threaded hole. The restricting member includes a first restricting portion and a threaded segment. The threaded segment is screwed to the threaded hole, and the restricting member is rotatable relative to the first rod to adjust a distance between the first restricting portion and the first rod. The locking mechanism includes a base, a core member, a locking member and an elastic member. The base is disposed on the second rod and includes a first through hole, and the locking member is movable with the core member and disposed in the base. The locking member is rotatable relative to the base between a first position and a second position. The locking member includes a side face and a second restricting portion, and the elastic member is abutted between the locking member and the base to bias the locking member toward the first position. The side face is tilted to a direction in which the first through hole is open and at least partially corresponding to the first through hole. When the first rod and the second rod are moved toward each other, the restricting member is inserted within the first through hole and abutted against the side face and the locking member is located in the second position. When the restricting member is then inserted further into the first through hole and the locking member returns to the first position by action of the elastic member, the second restricting portion is blocked by the first restricting portion so that the restricting member is non-withdrawable from the first through hole. When the core member drives the locking member to rotate to the second position, the second restricting portion is not blocked by the first restricting portion, and the restricting member is withdrawable from the first through hole.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a stereogram of a fixing assembly according to a preferable embodiment of the present invention;

FIG. 3 is a partial breakdown drawing of a preferable embodiment of the present invention;

FIG. 4 is a breakdown drawing of a locking mechanism according to a preferable embodiment of the present invention;

FIGS. 5 and 6 are partial cross-sectional views showing operation of a preferable embodiment of the present invention;

FIGS. 7 and 8 are cross-sectional views showing operation of a preferable embodiment of the present invention in another direction; and

FIGS. 9 and 10 are schematic diagrams of a preferable embodiment of the present invention in use.

### DETAILED DESCRIPTION OF THE PREFERRED EMBODIMENTS

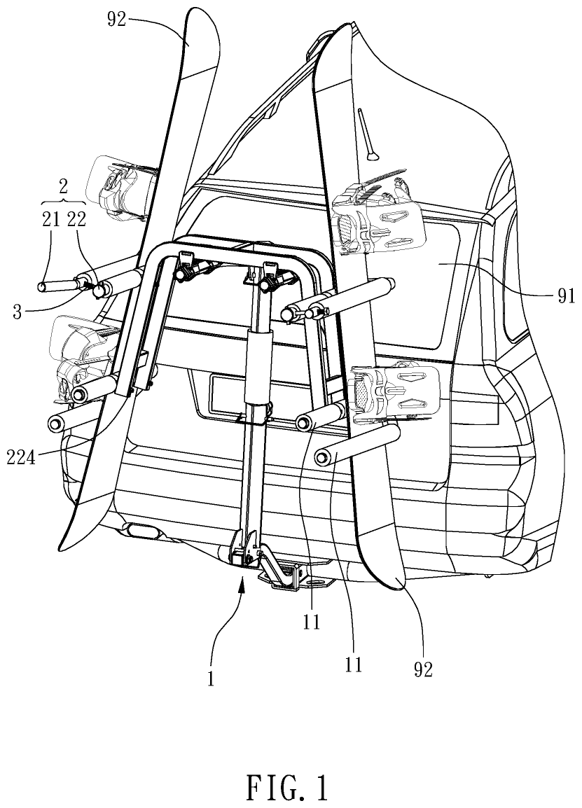

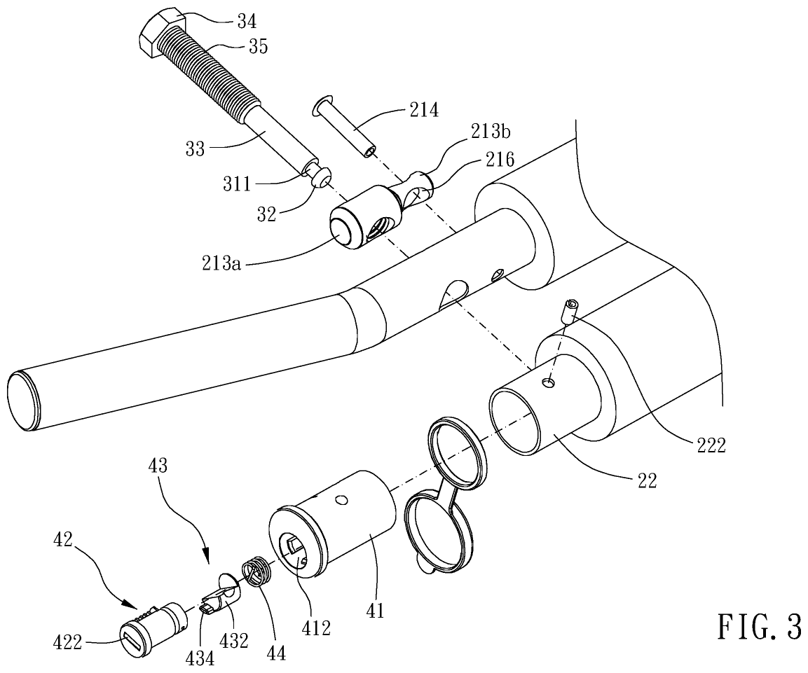

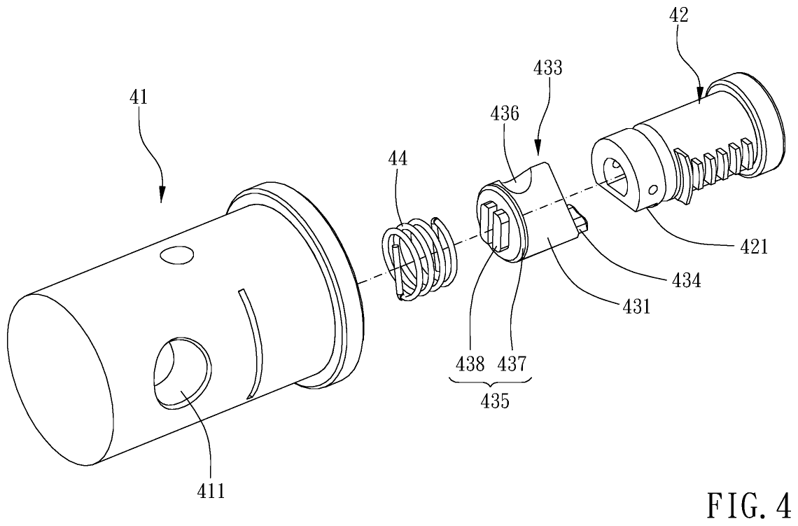

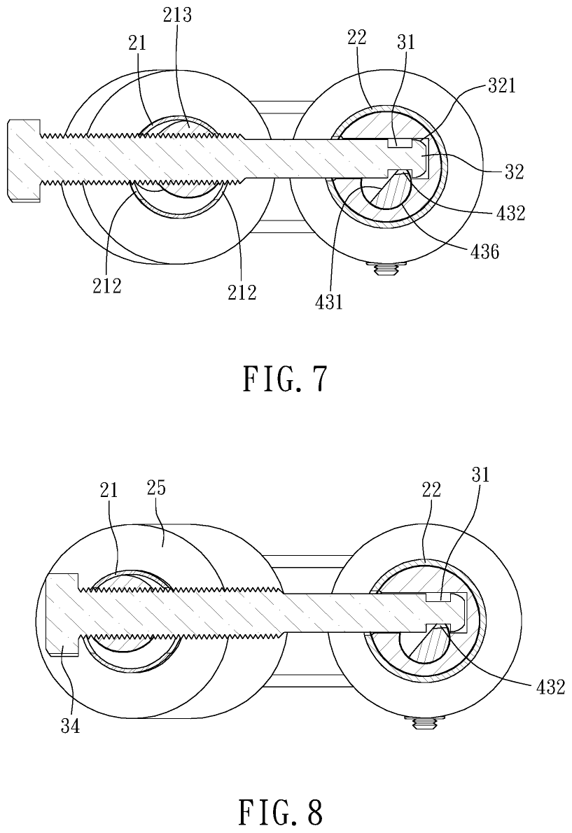

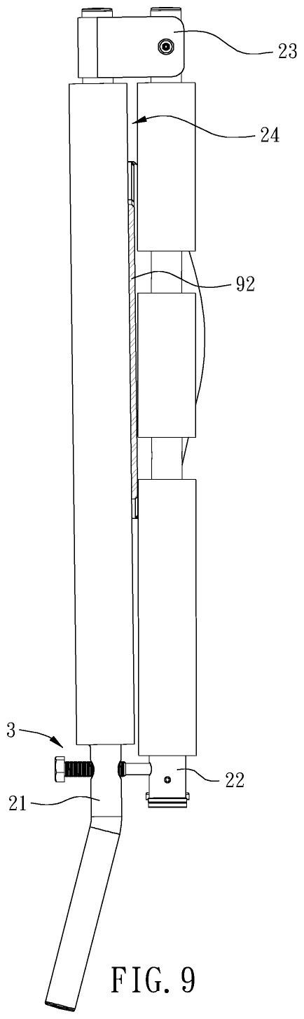

Please refer to FIGS. 1 to 9 for a preferable embodiment of the present invention. snowboard fixing frame 1 of the present invention includes a frame body 1, a fixing assembly 2, a restricting member 3 and a locking mechanism 4.

The frame body 1 is configured to be connected to a vehicle 91. In this embodiment, the frame body 1 is connected to a rear portion of the vehicle 91; however, the frame body 1 may be connected to a top portion of the vehicle 91.

The fixing assembly 2 is disposed on the frame body 1 and includes a first rod 21 and a second rod 22, and at least one of the first rod 21 and the second rod 22 is rotatable relative to the frame body 1 to clamp a snowboard 92. The first rod 21 has a threaded hole 211. In this embodiment, the frame body 1 further includes two fixation rods 11 defining an interval therebetween for insertion of the snowboard 92, and the two fixation rods 11 and the fixing assembly 2 are located at different levels so that the snowboard 92 can be secured upright.

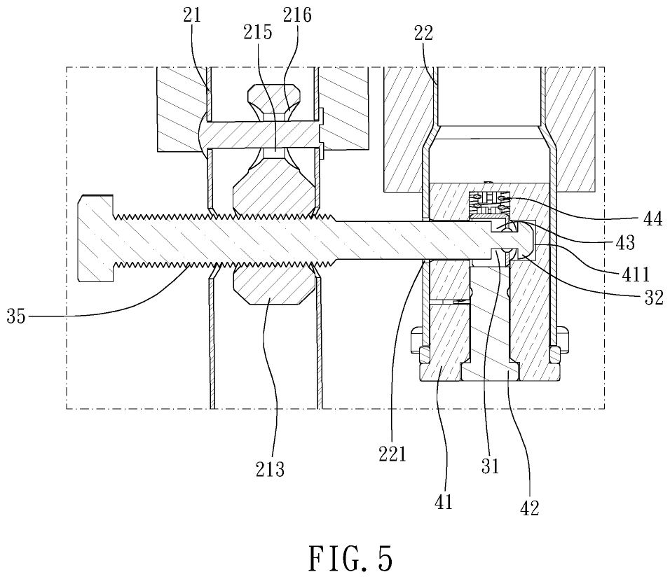

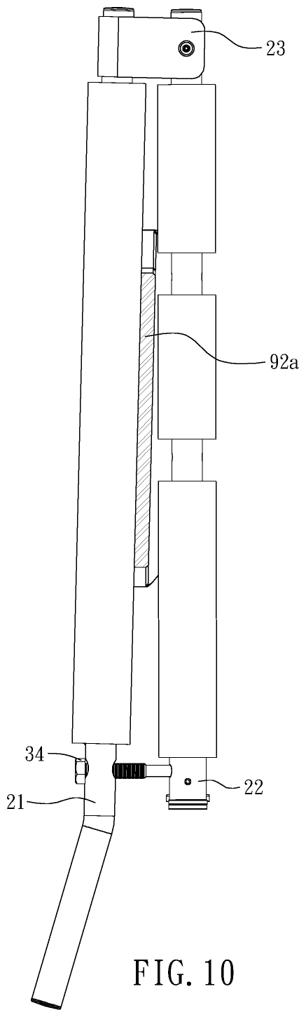

The restricting member 3 includes a first restricting portion 31 and a threaded segment 35. The threaded segment 35 is screwed to the threaded hole 211, and the restricting member 3 is rotatable relative to the first rod 21 to adjust a distance between the first restricting portion 31 and the first rod 21, as shown in FIGS. 5-10. Moreover, the first rod 21 is a hollow tube and has two third through holes 212 radially corresponding to each other, a column 213 is inserted within the first rod 21, and the threaded hole 211 is radially disposed through the column 213 and corresponds to the two third through holes 212, which provides good structural stability and is easy to assemble and replace.

The locking mechanism 4 includes a base 41, a core member 42, a locking member 43 and an elastic member 44. The base 41 is disposed on the second rod 22 and includes a first through hole 411. The locking member 43 is movable with the core member 42 and disposed in the base 41, and the locking member 43 is rotatable relative to the base 41 between a first position and a second position. The locking member 43 includes a side face 431 and a second restricting portion 432, and the elastic member 44 is abutted between the locking member 43 and the base 41 to bias the locking member 43 toward the first position. The side face 431 is tilted to a direction in which the first through hole 411 is open and at least partially corresponding to the first through hole 411. In this embodiment, the elastic member 44 is a coil spring and fixedly connected to the base 41 so that the core member 42 can return automatically.

In this embodiment, the base 41 includes a receiving hole 412, the core member 42 is received in the receiving hole 412, and an end of the core member 42 remote from the locking member 43 further includes a keyhole 422 for insertion of a key. The core member 42 is not rotatable relative to the base 41 until the key is inserted in the keyhole 422.

When the first rod 21 and the second rod 22 are moved toward each other, the restricting member 3 is inserted within the first through hole 411 and abutted against the side face 431 and the locking member 43 is located in the second position; as the restricting member 3 is then inserted further into the first through hole 411 and the locking member 43 returns to the first position by action of the elastic member 44, the second restricting portion 432 is blocked by the first restricting portion 31 so that the restricting member 3 is non-withdrawable from the first through hole 411 and so that the snowboard 92 is secured and locked to the frame body 1. The snowboard 92 can be removed from the frame body 1 as the core member 42 is rotated to drive the locking member 43 to the second position, where the second restricting portion 432 is not blocked by the first restricting portion 31 such that the restricting member 3 is withdrawable from the first through hole 411. As the first rod 21 and the second rod 22 swing away from each other and the restricting member 3 is withdrawn from the first through hole 411, the snowboard 92 is removable from the snowboard fixing frame, which is convenient and burglarproof.

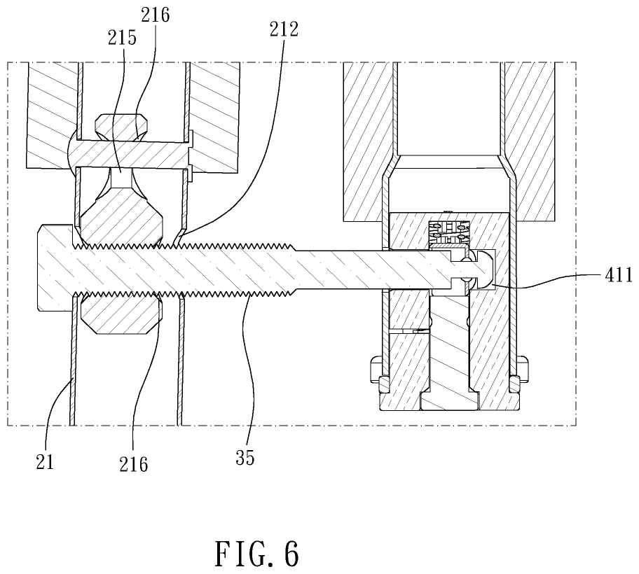

In this embodiment, a diametrical dimension of the column 213 is smaller than an inner diametrical dimension of the first rod 21 for relative movement, and the column 213 is movably restricted in the first rod 21 by a retainer 214 so as to restrict the column 213 when the restricting member 3 is removed from the threaded hole 211. A diametrical dimension of each of the two third through holes 212 is larger than a diametrical dimension of the threaded segment 35 so that the restricting member 3 is movable relative to the first rod 21 to be aligned with the first through hole 411, as shown in FIGS. 5 and 6. Specifically, the column 213 has a fourth through hole 215 penetrating therethrough, the retainer 214 is rod-shaped and is disposed through the fourth through hole 215, and a diametrical dimension of the fourth through hole 215 is larger than a diametrical dimension of the retainer 214 for sufficient movement of the restricting member 3. The column 213 includes a large diametric segment 213a and a small diametric segment 213b integrally connected with each other, the threaded hole 211 is disposed on the large diametric segment 213a, and the fourth through hole 215 is disposed on the small diametric segment 213b. The column 213 further includes a plurality of arcuate concave surfaces 216, each of the plurality of arcuate concave surfaces 216 is surrounded one of the threaded hole 211 and the fourth through hole 215, which allows slightly swinging of the restricting member 3 for easy operation. In other embodiments, the column may be restricted within the first rod only by the restricting rod; the column may have a single diametrical dimension.

Specifically, the fixing assembly 2 further includes a connecting member 23. The first rod 21 and the second rod 22 are spacedly connected to the connecting member 23, and one of the first rod 21 and the second rod 22 is rotatable relative to the connecting member 23. When the first rod 21 and the second rod 22 are parallel to each other, an interval 24 is defined between the first rod 21 and the second rod 22 and extends in a longitudinal direction of the fixing assembly 2. Therefore, the restricting member 3 is adjustable to move the first rod 21 toward the second rod 22 so as to clamp the snowboard 92 with a smaller thickness.

In this embodiment, the first rod 21 is longer than the second rod 22, the second rod 22 is a straight tube, and the first rod 21 includes a straight portion 217 and a gripping portion 218 inclined to the straight portion 217 in a direction remote from the second rod 22. The restricting member 3 is disposed on the straight portion 217, and a length of the straight portion 217 is larger than or equal to a length of the second rod 22. To uninstall the snowboard 92 secured between the first rod 21 and the second rod 22, the gripping portion 218 can be operated to move the first rod 21 toward the second rod 22 so as to reduces the urging force between the first restricting portion 31 and the second restricting portion 432, which is laborsaving and allows the locking mechanism 4 to be smoothly rotated.

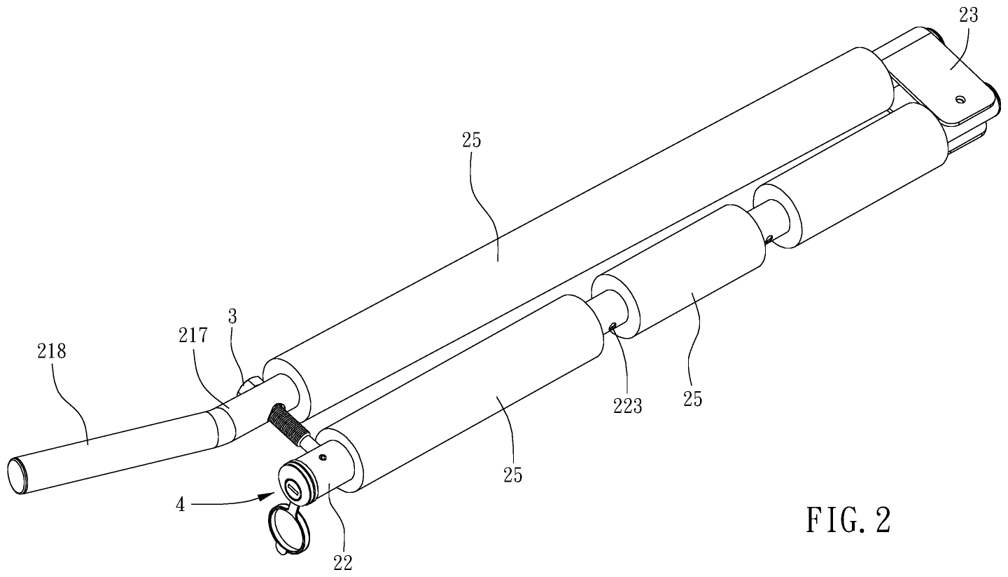

The second rod 22 has a plurality of restricting holes 223 disposed thereon, and a plurality of fasteners 224 are disposed within the plurality of restricting holes 223 and connect the second rod 22 with the frame body 1, which is convenient to be assembled and disassembled. The fixing assembly 2 further includes a plurality cushioning members 25 disposed on the first rod 21 and the second rod 22, and at least two of the plurality cushioning members 25 are spaced apart from one another and disposed on one of the first rod 21 and the second rod 22 so as to contact the snowboard 92 in a multipoint manner and provide stable restriction. In this embodiment, each of the plurality of restricting holes 223 is located between adjacent two of said cushioning members 25 so that the frame body 1 can be partially located between the two said cushioning members 25 for stable and easy assembling. When the first rod 21 and the second rod 22 are parallel to each other, at least one of the plurality cushioning members 25 disposed on the first rod 21 is spaced apart from the at least one of the plurality cushioning members 25 disposed on the second rod 22 so as to remain sufficient interval for adjustment, as shown in FIGS. 2, 5, 7 and 9.

Specifically, the restricting member 3 includes an abutting portion 32 and a body portion 33, the first restricting portion 31 is disposed between the body portion 33 and the abutting portion 32, and the threaded segment 35 is disposed on the body portion 33. In this embodiment, an end of the body portion 33 remote from the first restricting portion 31 includes a head portion 34 enlarged, the body portion 33 is disposed through the first rod 21, and the head portion 34 is blocked at a side of the first rod 21 remote from the second rod 22. When the head portion 34 is abutted against the first rod 21 and the first restricting portion 31 is blocked with the second restricting portion 432, the first rod 21 is non-parallel to the second rod 22, as shown in FIGS. 6, 8 and 10. The restricting member 3 allows the first rod 21 and the second rod 22 to provide sufficient force to secure a snowboard 92a with a larger thickness and avoid over-tightening. Therefore, the locking mechanism 4 can be operated smoothly and the snowboard 92a and the first rod 21 will not be bounced unexpectedly when the locking member 43 is moved to the second position, which is safe to use and avoids damage to the restricting member 3, the locking mechanism 4, and the snowboard 92a.

Preferably, a side of the abutting portion 32 remote from the body portion 33 includes a guiding surface 321, the first restricting portion 31 includes an annular groove 311, and the second restricting portion 432 is disengageably engaged within the annular groove 311. Since the guiding surface 321 is abutted against the side face 431, the locking member 43 can be driven, by the side face 431, to rotate to the second position.

Specifically, the locking member 43 includes a rotatable portion 433, a first assembling portion 434 and a second assembling portion 435 which are connected with two ends of the rotatable portion 433. The side face 431 and the second restricting portion 432 are disposed on the rotatable portion 433; the first assembling portion 434 is assembled with the core member 42 so that the core member 42 is rotatable with the locking member 43; the second assembling portion 435 is assembled with the elastic member 44 so that the elastic member 44 bias the second assembling portion 435 toward the first position.

In this embodiment, the rotatable portion 433 includes a semi-cylinder, the second restricting portion 432 is an arced surface of the semi-cylinder, and a first notch 436 is disposed between the second restricting portion 432 and the side face 431. When the guiding surface 321 is abutted against the side face 431, the locking member 43 can return to the first position via the first notch 436 so that the second restricting portion 432 can be engaged with the first restricting portion 31.

The first assembling portion 434 axially projects from the rotatable portion 433 and is eccentric relative to an axial direction of the rotatable portion 433, a second notch 421 is disposed on a side of the core member 42 toward the locking member 43 and is eccentric relative to an axial direction of the core member 42, and the first assembling portion 434 is inserted within the second notch 421 so that the core member 42 is rotatable with the locking member 43.

Specifically, the second assembling portion 435 includes a blocking wall 437 and two projections 438, an end of the rotatable portion 433 remote from the core member 42 includes the blocking wall 437 extending radially, an end of the blocking wall 437 remote from the rotatable portion 433 includes the two projections 438 extending axially, and an end of the elastic member 44 is disposed between the two projections between so that the elastic member 44 can drive the locking member 43 to rotate.

Preferably, the base 41 is inserted within the second rod 22, the second rod 22 includes a second through hole 221 disposed radially therethrough and corresponding to the first through hole 411 so that the first rod 21 can be inserted into the first through hole 411 easily, and a pin 222 is inserted radially within the base 41 and the second rod 22 to secure the base 41 to the second rod 22. The base 41 may be non-detachably fixed to the second rod 22 by welding, for example.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A snowboard fixing frame, including:
a frame body, configured to be connected to a vehicle;
a fixing assembly, disposed on the frame body, including a first rod and a second rod, at least one of the first rod and the second rod being rotatable relative to the frame body to clamp a snowboard, the first rod having a threaded hole;
a restricting member, including a first restricting portion and a threaded segment, the threaded segment screwed to the threaded hole, and the restricting member being rotatable relative to the first rod to adjust a distance between the first restricting portion and the first rod;
a locking mechanism, including a base, a core member, a locking member and an elastic member, the base being disposed on the second rod and including a first through hole, the locking member being movable with the core member and disposed in the base, the locking member being rotatable relative to the base between a first position and a second position, the locking member including a side face and a second restricting portion, the elastic member being abutted between the locking member and the base to bias the locking member toward the first position, the side face being tilted to a direction in which the first through hole is open and at least partially corresponding to the first through hole;
wherein when the first rod and the second rod are moved toward each other, the restricting member is inserted within the first through hole and abutted against the side face and the locking member is located in the second position; when the restricting member is then inserted further into the first through hole and the locking member returns to the first position by action of the elastic member, the second restricting portion is blocked by the first restricting portion so that the restricting member is non-withdrawable from the first through hole; when the core member drives the locking member to rotate to the second position, the second restricting portion is not blocked by the first restricting portion, and the restricting member is withdrawable from the first through hole.

2. The snowboard fixing frame of claim 1, wherein the restricting member includes an abutting portion and a body portion, the first restricting portion is disposed between the body portion and the abutting portion, and the threaded segment is disposed on the body portion.

3. The snowboard fixing frame of claim 2, wherein a sides of the abutting portion remote from the body portion includes a guiding surface, the first restricting portion includes an annular groove, and the second restricting portion is disengageably engaged within the annular groove.

4. The snowboard fixing frame of claim 2, wherein an end of the body portion remote from the first restricting portion includes a head portion enlarged; and when the head portion is abutted against the first rod and the first restricting portion is blocked with the second restricting portion, the first rod is non-parallel to the second rod.

5. The snowboard fixing frame of claim 1, wherein the locking member includes a rotatable portion, a first assembling portion and a second assembling portion which are connected with two ends of the rotatable portion, the side face and the second restricting portion are disposed on the rotatable portion, the first assembling portion is assembled with the core member, and the second assembling portion is assembled with the elastic member.

6. The snowboard fixing frame of claim 5, wherein the rotatable portion includes a semi-cylinder, the first restricting portion is an arced surface of the semi-cylinder, and a first notch is disposed between the first restricting portion and the side face.

7. The snowboard fixing frame of claim 5, wherein the first assembling portion axially projects from the rotatable portion and is eccentric relative to an axial direction of the rotatable portion, a second notch is disposed on a side of the core member toward the locking member and is eccentric relative to an axial direction of the core member, and the first assembling portion is inserted within the second notch.

8. The snowboard fixing frame of claim 5, wherein the second assembling portion includes a blocking wall and two projections, an end of the rotatable portion remote from the core member includes the blocking wall extending radially, an end of the blocking wall remote from the rotatable portion includes the two projections extending axially, and an end of the elastic member is disposed between the two projections.

9. The snowboard fixing frame of claim 1, wherein the base is inserted within the second rod, the second rod includes a second through hole disposed radially therethrough and corresponding to the first through hole, and a pin is inserted within the base and the second rod.

10. The snowboard fixing frame of claim 1, wherein the fixing assembly further includes a connecting member, the first rod and the second rod are spacedly connected to the connecting member, one of the first rod and the second rod is rotatable relative to the connecting member, and when the first rod and the second rod are parallel to each other, an interval is defined between the first rod and the second rod and extends in a longitudinal direction of the fixing assembly.

11. The snowboard fixing frame of claim 1, wherein the first rod is a hollow tube and has two third through holes radially corresponding to each other, a column is inserted within the first rod, and the threaded hole is radially disposed through the column and corresponds to the two third through holes.

12. The snowboard fixing frame of claim 11, wherein a diametrical dimension of each of the two third through holes is larger than a diametrical dimension of the threaded segment.

13. The snowboard fixing frame of claim 11, wherein a diametrical dimension of the column is smaller than an inner diametrical dimension of the first rod, and the column is movably restricted in the first rod by a retainer.

14. The snowboard fixing frame of claim 13, wherein the column has a fourth through hole penetrating therethrough, the retainer is rod-shaped and is disposed through the fourth through hole, and a diametrical dimension of the fourth through hole is larger than a diametrical dimension of the retainer.

15. The snowboard fixing frame of claim 1, wherein the first rod is longer than the second rod, the second rod is a straight tube, the first rod includes a straight portion and a gripping portion inclined to the straight portion in a direction remote from the second rod, and the restricting member is disposed on the straight portion.

16. The snowboard fixing frame of claim 1, wherein the second rod has a plurality of restricting holes disposed thereon, and a plurality of fasteners are disposed within the plurality of restricting holes and connect the second rod with the frame body.

17. The snowboard fixing frame of claim 1, wherein the fixing assembly further includes a plurality cushioning members disposed on the first rod and the second rod, and at least two of the plurality cushioning members are spaced apart from one another and disposed on one of the first rod and the second rod.

18. The snowboard fixing frame of claim 4, wherein a sides of the abutting portion remote from the body portion includes a guiding surface, the first restricting portion includes an annular groove, and the second restricting portion is disengageably engaged within the annular groove; the locking member includes a rotatable portion, a first assembling portion and a second assembling portion which are connected with two ends of the rotatable portion, the side face and the second restricting portion disposed on the rotatable portion, the first assembling portion is assembled with the core member, and the second assembling portion is assembled with the elastic member; the rotatable portion includes a semi-cylinder, the second restricting portion is an arced surface of the semi-cylinder, and a first notch is disposed between the second restricting portion and the side face; the first assembling portion axially projects from the rotatable portion and is eccentric relative to an axial direction of the rotatable portion, a second notch is disposed on a side of the core member toward the locking member and is eccentric relative to an axial direction of the core member, and the first assembling portion is inserted within the second notch; the second assembling portion includes a blocking wall and two projections, an end of the rotatable portion remote from the core member includes the blocking wall extending radially, an end of the blocking wall remote from the rotatable portion includes the two projections extending axially, and an end of the elastic member is disposed between the two projections; the base is inserted within the second rod, the second rod includes a second through hole disposed radially therethrough and corresponding to the first through hole, and a pin is inserted within the base and the second rod; the elastic member is a coil spring and fixedly connected to the base; the base includes a receiving hole, the core member is received in the receiving hole; an end of the core member remote from the locking member further includes a keyhole for insertion of a key, the core member is not rotatable relative to the base until the key is inserted in the keyhole; the frame body further includes two fixation rods defining an interval therebetween for insertion of the snowboard, and the two fixation rods and the fixing assembly are located at different levels; the fixing assembly further includes a connecting member, the first rod and the second rod are spacedly connected to the connecting member, one of the first rod and the second rod is rotatable relative to the connecting member, and when the first rod and the second rod are parallel to each other, an interval is defined between the first rod and the second rod and extends in a longitudinal direction of the fixing assembly; the first rod is a hollow tube and has two third through holes radially corresponding to each other, a column is inserted within the first rod, and the threaded hole is radially disposed through the column and corresponds to the two third through holes; a diametrical dimension of each of the two third through holes is larger than a diametrical dimension of the threaded segment; a diametrical dimension of the column is smaller than an inner diametrical dimension of the first rod, and the column is movably restricted in the first rod by a retainer; the column has a fourth through hole penetrating therethrough, the retainer is rod-shaped and is disposed through the fourth through hole, and a diametrical dimension of the fourth through hole is larger than a diametrical dimension of the retainer; the column includes a large diametric segment and a small diametric segment integrally connected with each other, the threaded hole is disposed on the large diametric segment, and the fourth through hole is disposed on the small diametric segment; the column further includes a plurality of arcuate concave surfaces, each of the plurality of arcuate concave surfaces is surrounded one of the threaded hole and the fourth through hole; the first rod is longer than the second rod, the second rod is a straight tube, the first rod includes a straight portion and a gripping portion inclined to the straight portion in a direction remote from the second rod, and the restricting member is disposed on the straight portion; a length of the straight portion is larger than or equal to a length of the second rod; the second rod has a plurality of restricting holes disposed thereon, a plurality of fasteners are disposed within the plurality of restricting holes and connect the second rod with the frame body; the fixing assembly further includes a plurality cushioning members disposed on the first rod and the second rod, and at least two of the plurality cushioning members are spaced apart from one another and disposed on one of the first rod and the second rod; each of the plurality of restricting holes is located between adjacent two of said cushioning members; and when the first rod and the second rod are parallel to each other, at least one of the plurality cushioning members disposed on the first rod is spaced apart from at least one of the plurality cushioning members disposed on the second rod.
